(19) United States
(12) Patent Application Publication
(10) Pub. No.: US 2010/0119332 A1
(43) Pub. Date: May 13, 2010

(54) SHEET FINISHING DEVICE

(75) Inventor: Shogo OZAWA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/611,731

(22) Filed: Nov. 3, 2009

Related U.S. Application Data
(60) Provisional application No. 61/112,640, filed on Nov. 7, 2008.

(51) Int. Cl. B42C 19/00

(52) U.S. Cl. 412/1; 412/18; 412/16

(57) ABSTRACT

A sheet finishing device winds a paper tape at a stapling position on a sheet bundle and thus binds the sheet bundle. The sheet finishing device cuts a used sheet that is un-reusable for image formation to produce a paper tape for binding the sheet bundle.

### CROSS-REFERENCE TO RELATED APPLICATION

This application is based upon and claims the benefit of priority from provisional U.S. Applications 61/112,640 filed on Nov. 7, 2008, the entire contents of which are incorporated herein by reference.

### TECHNICAL FIELD

The present invention relates to a sheet finishing device which finishes a sheet on which an image is formed by an image forming apparatus of a copy machine, printer or MFP (multi-functional peripheral).

### BACKGROUND

A sheet finishing device binds a sheet on which an image is formed by an image forming apparatus. As a sheet binding technique, stapling may be used in which plural sheets are bound with metal staples. However, stapling with metal staples may impair safety of the user. Moreover, metal staples must be removed from stapled sheets at the time of recycling the sheets.

Meanwhile, recently, for example, JP-A-8-39959, JP-A-10-871 and JP-A-10-872 disclose devices that bind sheets with a dedicated adhesive tape. However, in the conventional devices, a dedicated adhesive tape having adhesiveness needs to be loaded.

It is desirable to develop a sheet finishing device which does not require separate preparation of a dedicated binding tape to bind sheets on which an image is formed, and which enables reduction in running costs, improved easiness of maintenance, elimination of the need to remove staples at the time of recycling, and more effective utilization of sheets.

### SUMMARY

According to an embodiment, a sheet finishing device includes a processing tray which supports sheets having an image formed thereon by an image forming unit, a binding unit which binds a plurality of the sheets on the processing tray by using a paper tape, and a stacker which stacks a sheet bundle bound by the binding unit.

### DESCRIPTION OF THE DRAWINGS

FIG. 1 is a schematic view of configuration showing a sheet finishing device according to a first embodiment;

FIG. 2A, FIG. 2B, FIG. 2C and FIG. 2D are schematic perspective views showing procedures for cutting used sheets by a tape producing unit according to the first embodiment;

FIG. 3 is a schematic perspective view showing the cutting by a lower cutter edge and an upper cutter edge of the tape producing unit according to the first embodiment;

FIG. 4A, FIG. 4B and FIG. 4C are schematic explanatory views showing procedures for accumulating, in a tape supply unit, paper tapes cut by the tape producing unit according to the first embodiment;

FIG. 5 is a schematic perspective view showing the tape supply unit according to the first embodiment;

FIG. 6 is a schematic view of configuration showing a stapling unit according to the first embodiment;

FIG. 7A, FIG. 7B, FIG. 7C, FIG. 7D, FIG. 7E, FIG. 7F and FIG. 7G are schematic explanatory views showing sheet binding procedures using the stapling unit according to the first embodiment;

FIG. 8 is a flowchart showing the production of paper tapes according to the first embodiment;

FIG. 9 is a flowchart showing the stapling with a paper tape according to the first embodiment;

FIG. 10A, FIG. 10B and FIG. 10C are schematic explanatory views showing procedures for bending a paper tape according to the first embodiment;

FIG. 11 is a partial perspective view showing a sheet bundle stapled with a paper tape according to the first embodiment;

FIG. 12 is a schematic view of configuration showing a sheet finishing device according to a second embodiment;

FIG. 13 is a schematic perspective view showing a tape supply unit according to the second embodiment;

FIG. 14 is a schematic view of configuration showing a stapling unit according to the second embodiment;

FIG. 15A, FIG. 15B, FIG. 15C, FIG. 15D and FIG. 15E are schematic explanatory views showing sheet binding procedures using the stapling unit according to the second embodiment; and

FIG. 16 is a schematic perspective view showing a tape forming unit and a tape supply unit according to a modification.

### DETAILED DESCRIPTION

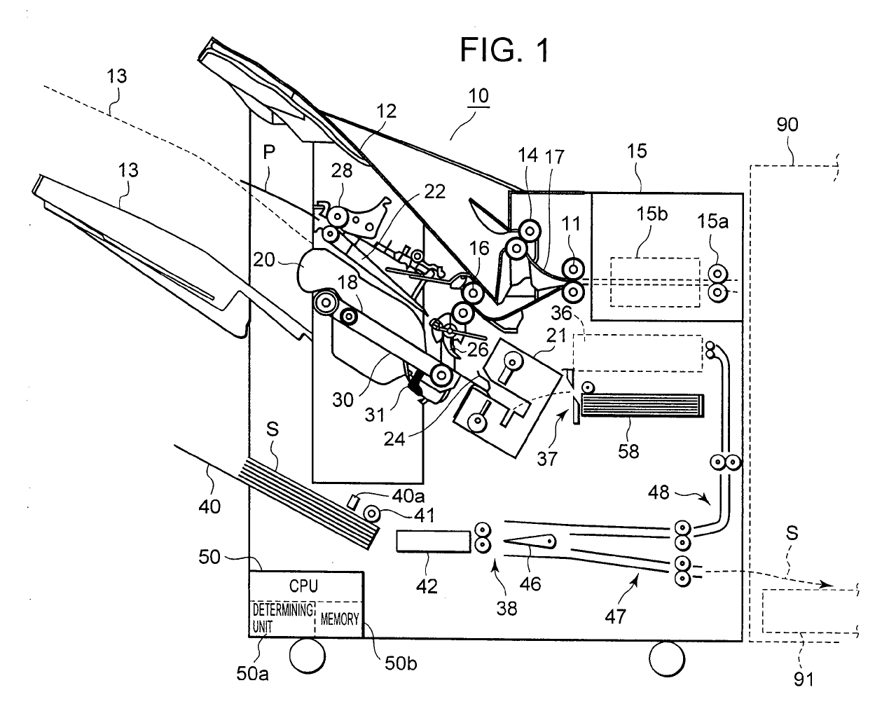

Hereinafter, a first embodiment will be described with reference to the attached drawings. FIG. 1 is a schematic view of configuration showing a sheet finishing device 10 according to the first embodiment. The sheet finishing device 10 discharges a sheet P discharged from an image forming apparatus 90 such as an MFP having an image forming unit to form an image on a sheet, to a fixed tray 12 or a placing tray 13 as a stacker. CPU50 controls the sheet finishing device 10. The CPU50 includes a determining unit 50a and a memory 50b.

The sheet finishing device 10 has a punch unit 15 as a punching unit which punches a hole in the sheet P discharged after image formation by the image forming apparatus 90. The punch unit 15 has a first roller 15a and a punch section 15b. The sheet finishing device 10 has a second roller 11 which carries the sheet P passed through the punch unit 15, and a first gate 17 which allocates the sheet P to the direction of a first exit roller 14 or to the direction of a second exit roller 16.

The sheet finishing device 10 has a processing tray 18 which finishes the sheet P allocated to the second exit roller 16 by the first gate 17, and a stapling unit 21 as a binding unit which binds plural sheets on the processing tray 18 with a paper tape T. The sheet finishing device 10 has a lateral alignment board 20 which laterally aligns the sheets P on the processing tray 18, a paddle 26 which longitudinally aligns the sheets P on the processing tray 18, an ejector 24 which discharges the bundled sheets P from the stapling unit 21 after the sheets P on the processing tray 18 are bound, and a bundle pawl belt 30 having a bundle pawl 31 which discharges the bundled sheets P to the placing tray 13.

A standby tray 22 which stands by for supply of sheets to the processing tray 18 is arranged above the processing tray 18. A standby tray roller 28 which discharges sheets directly to the placing tray from the standby tray 22 is arranged above the standby tray 22.

The sheet finishing device 10 has a tape producing unit 36 as a tape forming unit which produces a paper tape T to be used by the stapling unit 21, and a tape supply unit 37 as a tape supply portion which supplies the produced paper tape to the stapling unit 21.

The sheet finishing device 10 has a sheet supply unit 38 as a sheet supply portion which supplies a used sheet S to the direction of the image forming apparatus 90. The sheet supply unit 38 supplies the used sheet S to a paper supply tray 91 of the image forming apparatus 90 if the used sheet S is reusable. The sheet supply unit 38 supplies the used sheet S to the tape producing unit 36 if the used sheet S is not reusable.

The sheet supply unit 38 has a used sheet tray 40 on which the used sheet S is to be placed, a sheet detection switch 40a which detects the presence or absence of the used sheet S on the used sheet tray 40, a sheet pickup roller 41 which picks up the used sheet S, a scanner 42 which scans creases and scratches on the used sheet S, a second gate 46 which allocates the used sheet S to the direction of the image forming apparatus 90 or to the direction of the tape producing unit 36, a first carrying path 47 which leads the used sheet S to the paper supply tray 91, and a second carrying path 48 which leads the used sheet S to the tape producing unit 36.

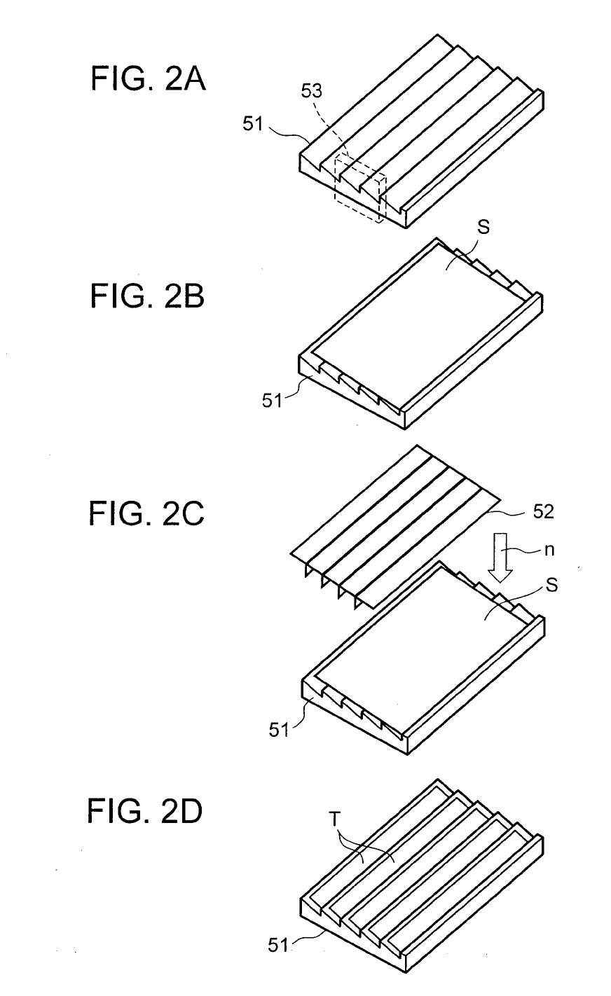

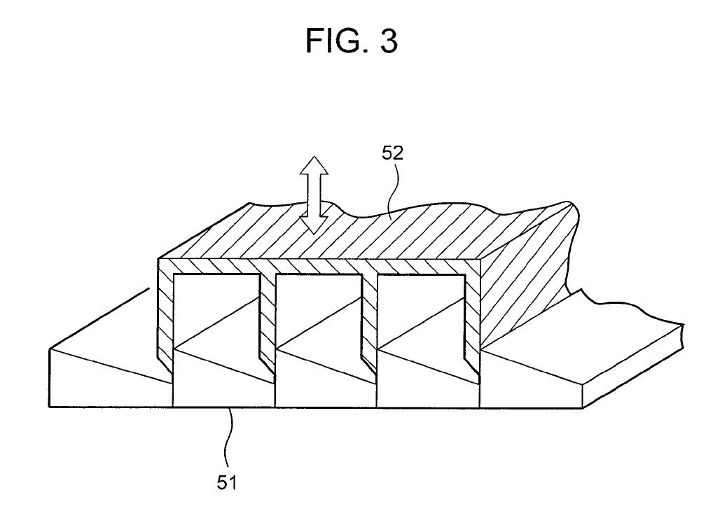

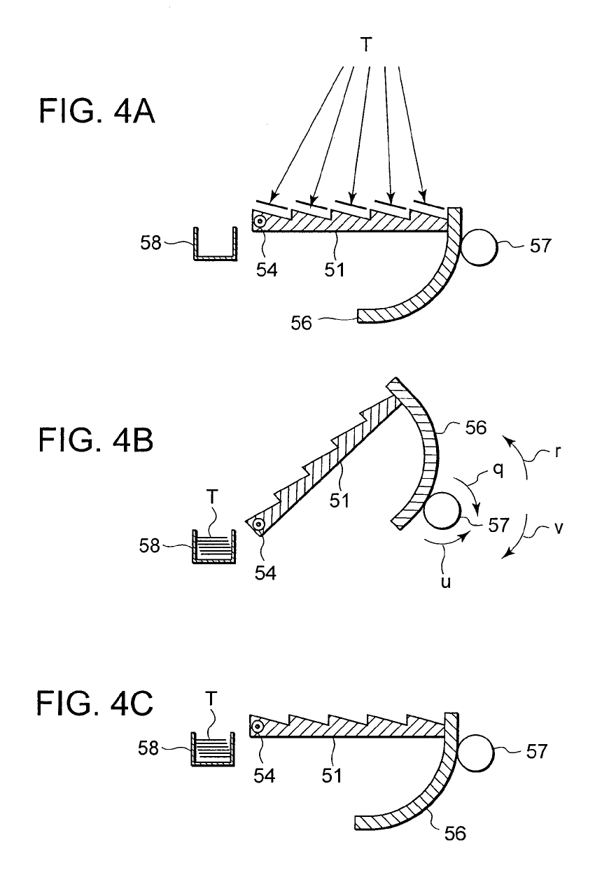

Scanned data from the scanner 42 is inputted into the determining unit 50a of the CPU 50. The memory 50b of the CPU 50 stores a threshold value of damage. The determining unit 50a compares the scanned data with the threshold value of damage. The determining unit 50a determines that the used sheet s is reusable when the scanned data is less than a threshold value of damage. In case that the used sheet S records used times in advance, the scanner 42 scans the number of used times of the used sheet S. The determining unit 50a compares the scanned data with the threshold value of used times which stored in the memory 50b. The determining unit 50a determines that the used sheet s is reusable when scanned data is smaller than a threshold value of used times. The tape producing unit 36 is shown in FIG. 2A to FIG. 2D, FIG. 3, and FIG. 4A to FIG. 4C. The tape producing unit 36 has a plate-like lower cutter edge 51 having an edge with a saw-toothed cross section on the surface, and an upper cutter edge 52 which the edge part of the lower cutter edge 51 rubs against to cut the used sheet S into paper tapes T. The upper cutter edge 52 moves up and down above the lower cutter edge 51.

The lower cutter edge 51 rotates about a shaft 54. The end on the rotating side of the lower cutter edge 51 has a rack 56. The rack 56 meshes with a pinion 57. As the pinion 57 rotates, the rack 56 and the lower cutter edge 51 rotate in a reciprocating manner.

The tape supply unit 37 is shown in FIG. 5. The tape supply unit 37 has a tape tray 58 on which the paper tapes T produced by the tape producing unit 36 are accumulated, a tape pickup roller 60 which takes out a paper tape T from the tape tray 58, a tape cutter 61 which cuts the paper tape T, and a carrying guide 62 and a carrying roller 63 which carry the paper tape T to the stapling unit 21. The tape cutter 61 has a fixed lower edge 61a, and an upper edge 61b which moves up and down.

In the tape supply unit 37, the tape pickup roller 60, the tape cutter 61 which cuts the paper tape T, and the carrying guide 62 and the carrying roller 63 which carry the paper tape T to the stapling unit 21 are arranged on the rear side and the front side of the sheet finishing device 10. The tape supply unit 37 can move the tape tray 58 on which the paper tapes T produced by the tape producing unit 36 are accumulated, together with the stapling unit 21, to the rear side and the front side of the sheet finishing device 10.

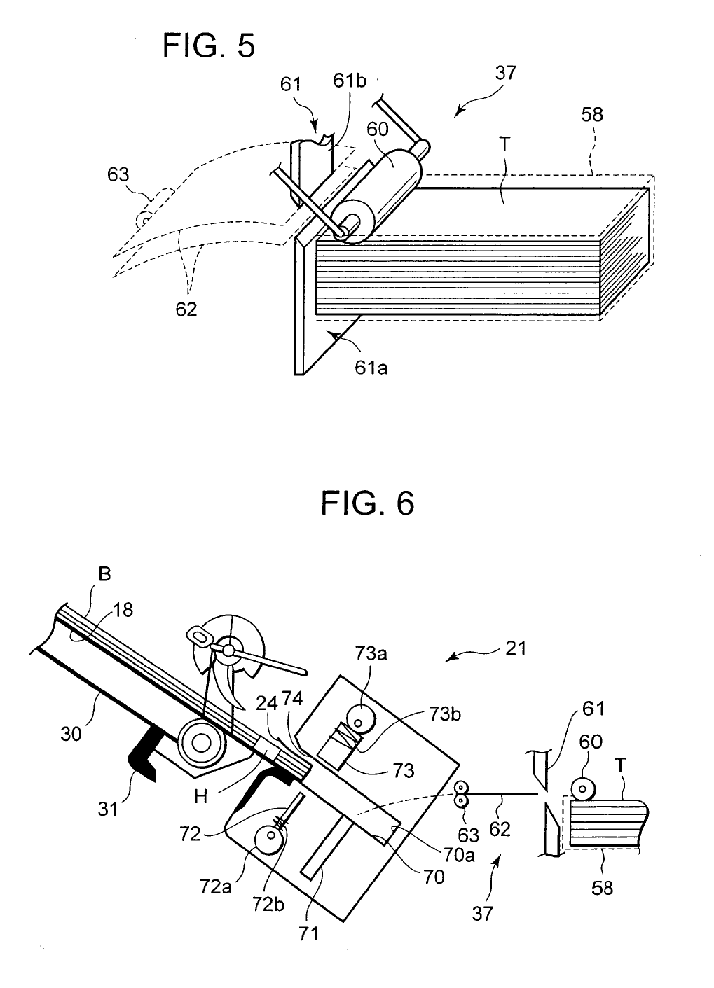

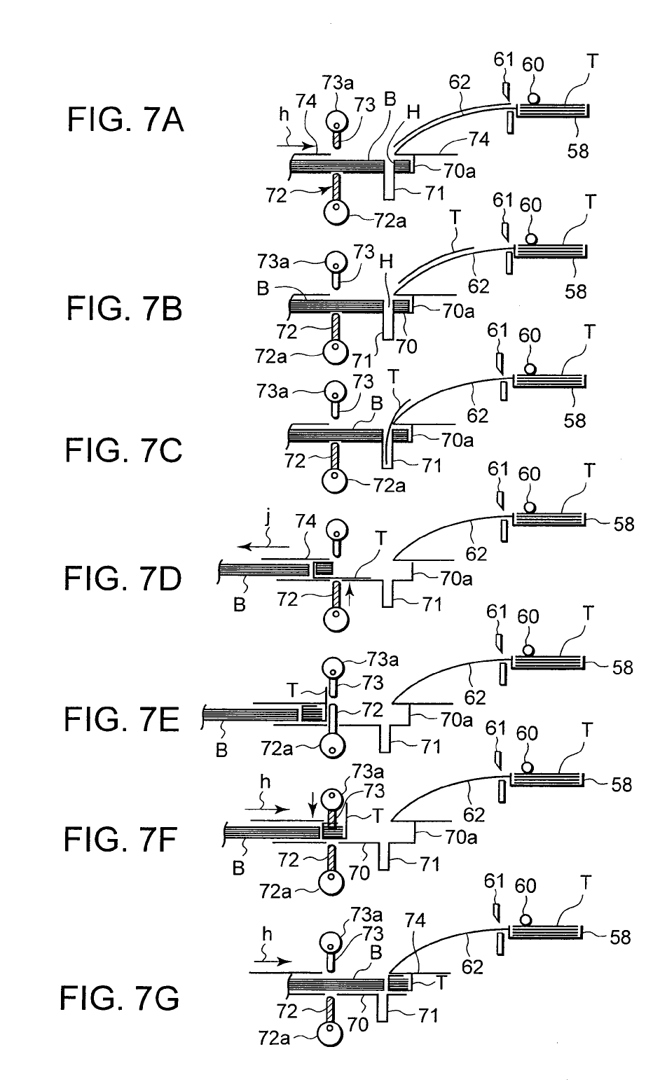

The stapling unit 21 is shown in FIG. 6 and FIG. 7A to FIG. 7G. In the sheet finishing device 10, the stapling unit 21 can slide to the front or rear side and can select stapling one part or two parts in a sheet bundle B. The stapling unit 21 has a slit 71 for inserting the paper tape T therein on a bundle supporting unit 70 which supports the sheet bundle B, and a bending member 72 for winding the paper tape T on the sheet bundle B. The bending member 72 is made to slide by the rotation of a first cam 72a and by a first spring 72b. Above the bundle supporting unit 70, a stamp 73 which pastes glue to the paper tape T wound on the sheet bundle D, and a bundle carrying guide 74 for the sheet bundle B are provided. The stamp 73 is made to slide by the rotation of a second cam 73a and by a second spring 73b.

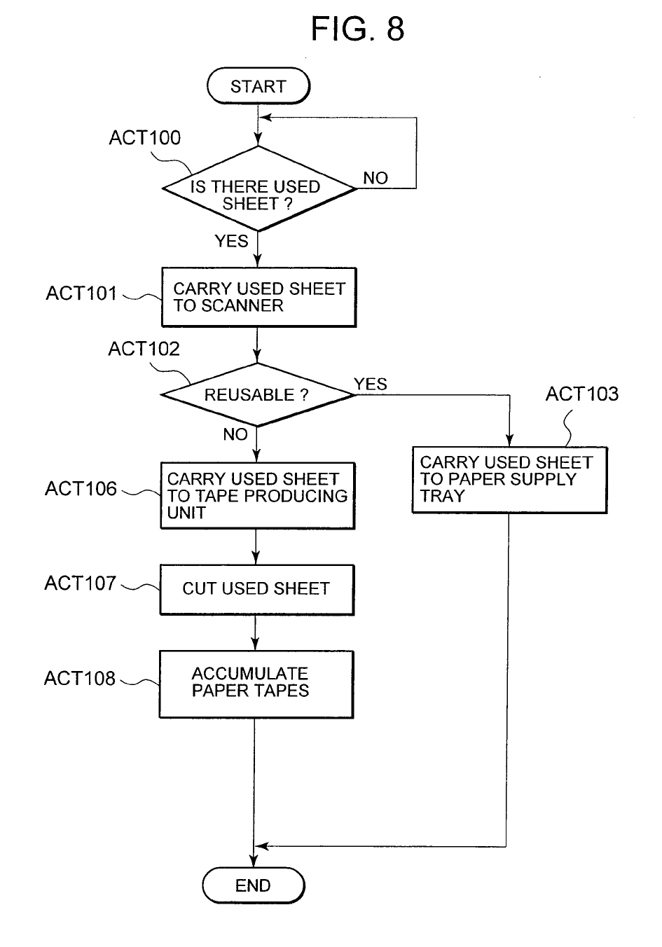

The production of the paper tape T will be described with reference to the flowchart of FIG. 8. At the time of producing the paper tape T, the used sheet S is placed on the used sheet tray 40. As the sheet detection switch 40a detects the used sheet S (Yes in ACT 100), the sheet pickup roller 41 carries the used sheet S to the scanner 42 (ACT 101). In case that the used sheet S is reusable from the scanned data of the scanner 42 (Yes in ACT 102), the sheet supply unit 38 carries the used sheet S to the paper supply tray 91 of the image forming apparatus 90 (ACT 103).

In case that the used sheet S is not reusable from the scanned data of the scanner 42 (No in ACT 102), the sheet supply unit 38 carries the used sheet to the tape producing unit 36 (ACT 106). The tape producing unit 36 cuts the used sheet S (ACT 107). The cut paper tapes T are accumulated on the tape tray (ACT 108).

At the time of producing the paper tapes T, in the tape producing unit 36, (1) the used sheet S carried from the second carrying path 48 is placed on the lower cutter edge 51 in the state where the lower cutter edge 51 is kept horizontal (FIG. 2B). The position on the lower cutter edge 51 where the used sheet S is placed is regulated by a stopper 53. (2) The upper cutter edge 52 is lowered in the direction of arrow n (FIG. 2C). As shown in FIG. 3, the upper cutter edge 52 rubs against the lower cutter edge 51 and thus cuts the used sheet S in the shape of paper tapes T (FIG. 2D).

After the paper tapes T are formed, (3) the pinion 57 is rotated in the direction of arrow q, thereby rotating the rack 56 and the lower cutter edge 51 in the direction of arrow r. The lower cutter edge 51 becomes inclined and the paper tapes T on the lower cutter edge 51 falls and accumulates on the tape tray 58 of the tape supply unit (FIG. 4B). (4) As the pinion 57 is rotated in the direction of arrow u, the rack 56 and the lower cutter edge 51 are rotated in the direction of arrow v and the lower cutter edge 51 becomes horizontal again (FIG. 4C).

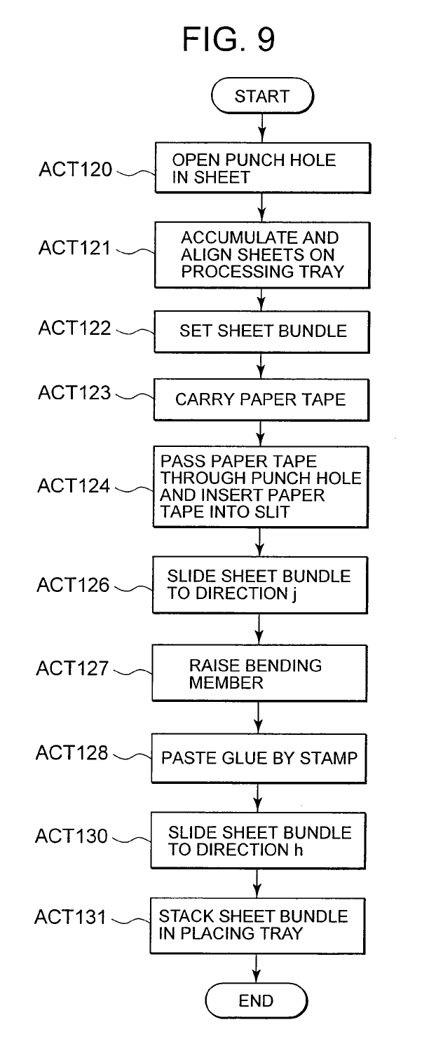

The stapling with the paper tape T will be described with reference to the flowchart of FIG. 9. The punch unit 15 forms a punch hole H at a stapling position on the sheets P on which an image is formed by the image forming apparatus in staple process (ACT 120). The sheets P are carried to the second roller 11. The sheets P are allocated toward the second exit roller 16 from the second roller 11 and then accumulated and aligned on the processing tray 18 (ACT 121).

The sheet bundle B on the processing tray 18 is slid in the direction of arrow h, then abutted on a sidewall 70a of the bundle supporting unit 70, and set at a stapling start position on the bundle supporting unit 70 (ACT 122). The position of the punch hole H in the sheet bundle B set at the stapling start position coincides with the position of the slit 71 of the bundle supporting unit 70 (FIG. 7A). As stapling starts, the paper tape T on the tape tray 58 is carried to the stapling unit 21 (ACT 123). The tape supply unit 37 takes out the paper tape T on the tape tray 58 by the tape pickup roller 60. The paper tape T thus taken out is cut to a required length by the tape cutter 61 and is carried to the stapling unit 21 along the carrying guide 62 by the carrying roller 63 (FIG. 7B).

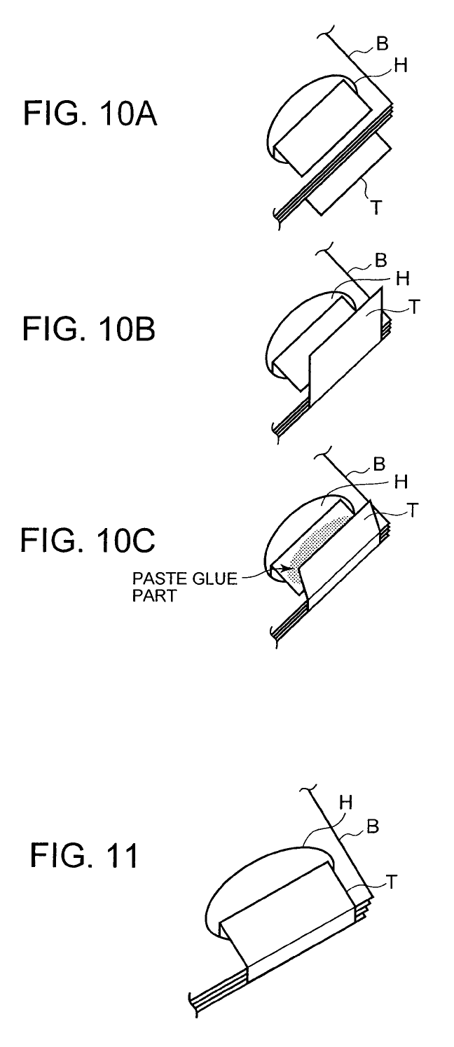

The paper tape T is passed through the punch hole H in the sheet bundle B and then inserted in the slit 71 of the supporting unit 70 (ACT 124, FIG. 7C). The sheet bundle B is slid in the direction of arrow j and front edge position of the sheet bundle B is made to coincide with the position of the bending member 72 (ACT 126). Front edge of the paper tape T is regulated by the bundle carrying guide 74 and bent along the surface of the sheet bundle B (FIG. 7D, FIG. 10A). The first cam 72a is rotated to raise the bending member 72, and the paper tape T is bent along the front edge of the sheet bundle B (ACT 127, FIG. 7E, FIG. 10B).

The first cam 72a is rotated and the bending member 72 is lowered by the first spring 72b. The sheet bundle B is thus slid in the direction of arrow h and set at a gluing position. The second cam 73a is rotated to lower the stamp 73 and glue is pasted to the paper tape T bent along the surface of the sheet bundle B (ACT 128, FIG. 7F, FIG. 10C).

The second cam 73a is rotated and the stamp 73 is raised by the second spring 73b. The sheet bundle B is slid in the direction of arrow h (ACT 130). The rear edge of the paper tape T is regulated and bent by the bundle carrying guide 74 and bonded to the gluing position of the paper tape T (FIG. 7G). As shown in FIG. 11, the paper tape T is wound between the punch hole H and the edge of the sheet bundle B and the sheet bundle B is thus stapled with the paper tape T. The sheet bundle B with its stapling completed with the paper tape T is taken out of the stapling unit 21 by the ejector 24. The sheet bundle B is carried on the processing tray 18 by the bundle pawl 31 interlocked with the turn of the bundle pawl belt 30 and is stacked in the placing tray 13 (ACT 131).

According to the first embodiment, the paper tape T is wound between the punch hole H in the sheet bundle B and the edge of the sheet bundle B, thus binding the sheet bundle B. Compared with the stapling with metal staples, there is no risk of injuring the handler's hand and user safety is provided. In the case of recycling the sheets P, the need to remove metal staples is eliminated. According to the first embodiment, the paper tape T used to bind the sheet bundle is made of the used sheet S. A sheet that is not reusable for image formation is cut to produce the paper tape T. More effective utilization of the used sheet S is realized.

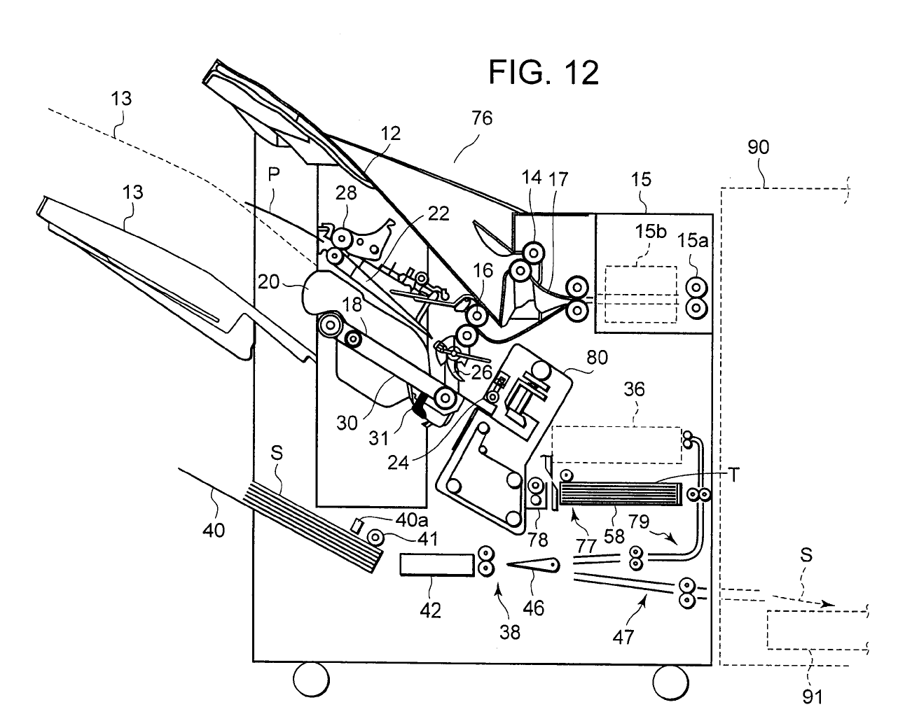

Next, a second embodiment will be described. The second embodiment differs from the first embodiment in the mechanism of the binding unit and the tape supply unit. In the second embodiment, the same parts of the configuration as those of the first embodiment are denoted by the same reference numerals and will not be described further in detail. In the second embodiment, a stapling unit 80 which is already known in JP-A-8-39959, JP-A-10-871 and JP-A-10-872 is used as a binding unit. As shown in FIG. 12, a tape supply unit 77 as a tape supply portion of a sheet finishing device 76 has a gluing unit 78 which pastes glue on the paper tape T used in the stapling unit 80. In the second embodiment, a third carrying path 79 is provided which leads the used sheet S to the tape producing unit 36.

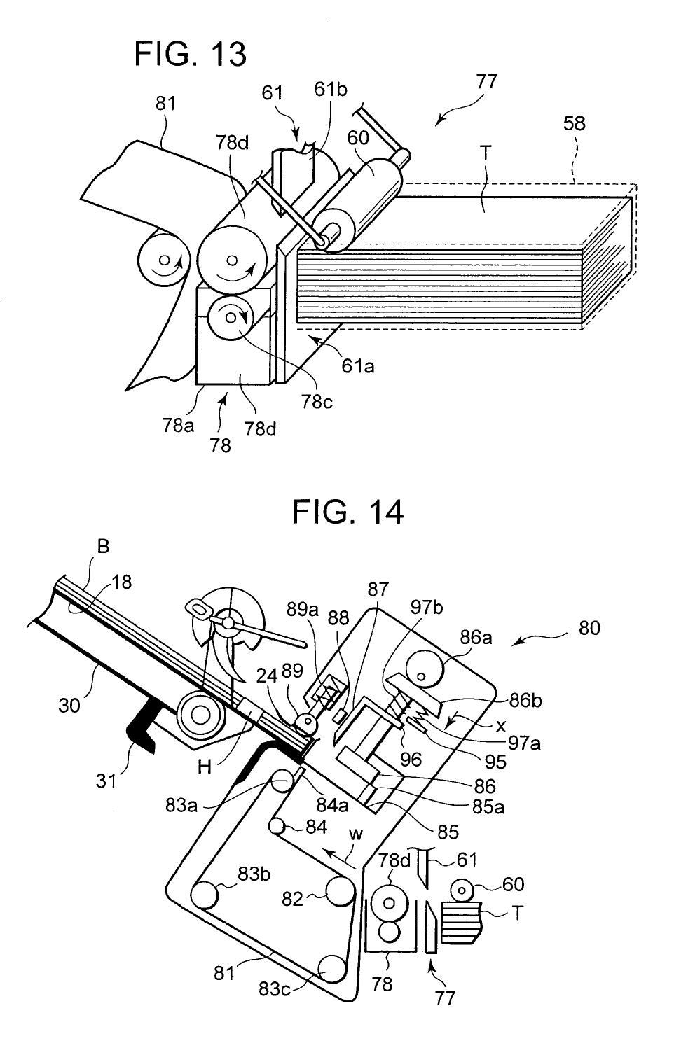

The tape supply unit 77 is shown in FIG. 13. The tape supply unit 77 has the tape tray 58, the tape pickup roller 60 and the tape cutter 61, and has a gluing unit 78 which pastes the glue on the paper tape T, at a position close to the tape cutter 61. The gluing unit 78 supplies glue 78b stored in a glue tank 78a to a gluing roller 78d via an intermediate roller 78c. In the tape supply unit 77, the tape pickup roller 60, the tape cutter 61 and the gluing unit 78 are arranged to the rear side and the front side of the sheet finishing device 10. In the tape supply unit 77, the tape tray 58 on which the paper tapes T produced by the tape producing unit 36 are accumulated is movable to the rear side and the front side of the sheet finishing device 10, together with the stapling unit 80.

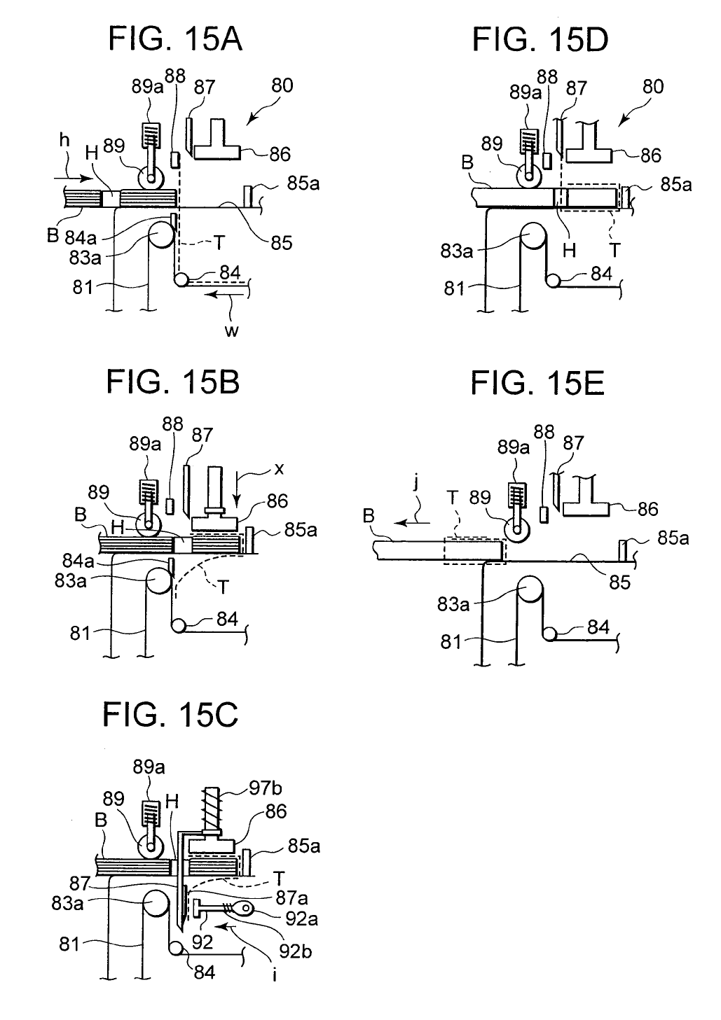

The stapling unit 80 is shown in FIG. 14 and FIG. 15A to FIG. 15E. The stapling unit 80 has an endless plastic film 81 which carries the paper tape T pasted the glue by the tape supply unit 77. The plastic film 81 is laid over a driving roller 82, a separation roller 83a, and first and second tension rollers 83b and 83c, and turns in the direction of arrow w. The plastic film 81 has the glued paper tape T pasted thereto and carries the paper tape T in the direction of arrow w. The plastic film 81 separates the pasted paper tape T at the position of the separation roller 83a.

A guide pin 84 which guides the paper tape T along the plastic film 81 is pressed in contact with the outer circumference of the plastic film 81. A separation guide 84a which separates the front edge of the paper tape T from the plastic film 81 is brought close to the outer circumference of the plastic film 81.

The stapling unit 80 has a stopper 85a which regulates the stapling position of the sheet bundle B, in a bundle supporting unit 85. The stapling unit 80 has a holding plate 86 for binding the paper tape T on the sheet bundle B, a tape guide pin 87 which moves up and down at the position of the punch hole H formed in the sheet bundle B, an attachment piece 88, and a holding roller 89, above the bundle supporting unit 85. The holding plate 86 is attached to a press-down member 86b which is moved up and down by the rotation of a cam 86a. When the tape guide pin 87 is moved down, the paper tape T is pasted to the tape guide pin 87 and a pasting part 87a which passes through the punch hole His formed. A stamp 92 which abuts the rear end of the paper tape T to the tape guide pin 87 is brought close to the outer circumference of the plastic film 81. The stamp 92 is slid by the rotation of a third cam 92a and by a third spring 92b.

A restoration spring 97a and a holding spring 97b act between the press-down member 86b, and a fixed bracket 95 and a supporting bracket 96 of the tape guide pin 87. When the cam 86a rotates to press down the press-down member 86b to the direction of arrow x, the holding plate 86 is lowered. As the press-down member 86b is pressed down to the direction of arrow x, the tape guide pin 87 is lowered by the restoration spring 97a and the holding spring 97b. The holding roller 89 is lightly energized to the direction of the sheet P by a spring 89a. The holding roller 89 moves up and down according to the thickness of plural sheets P.

As the stapling starts, the tape supply unit 77 takes out the paper tape T on the tape tray 58 with the tape pickup roller 60 and causes the paper tape T to pass the gluing roller 78d so that paper tape T is pasted the glue. The paper tape T is cut to a required length by the tape cutter 61 and supplied to the stapling unit 80.

On the processing tray 18, the aligned sheet bundle B is slid to the direction of arrow h to a tape winding start position on the bundle supporting unit 76, and the stapling with the paper tape T is started then. When the sheet bundle B reaches the winding start position, the front edge of the sheet bundle B pushes up the holding roller 89 against the spring 89a. As the stapling is started, the plastic film 81 turns in the direction of arrow w. The stapling unit 80 glues a pasted paper tape T on the endless plastic film 81 and carries the paper tape T. The guide pin 84 guides the paper tape T on the plastic film 81. The paper tape T reaches the separation roller 83a. The paper tape T is separated from the plastic film 81 by the separation guide 84a provided at the position of the separation roller 83a. The front edge of the paper tape T sequentially separated from the plastic film 81 is glued to the attachment piece 88 situated above (FIG. 15A).

The sheet bundle B further slides to the direction of arrow h to the position where the sheet bundle is abutted against the stopper 85a. The punch hole H in the sheet bundle B is situated right below the tape guide pin 87. The front edge of the paper tape T separates from the attachment piece 88 and adheres to the surface of the sheet bundle B. The cam 86a is rotated and the press-down member 86b is pressed down to the direction of arrow x. The distal end side of the paper tape T is thus made to adhere to the sheet bundle B by the holding plate 86 (FIG. 15B). As the press-down member 86b is pressed down to the direction of arrow x, the tape guide pint 87 is pressed down by the restoration spring 97a and the holding spring 97b. The tape guide pin 87 passes through the punch hole H of the sheet bundle B and falls between the separation roller 83a and the rear end of the paper tape T. The third cam 92a is rotated and the stamp 92 is slid in the direction of arrow i. The rear end of the paper tape T is thus pressed to contact the tape guide pin 87 (FIG. 15C). The third cam 92a is rotated and the stamp 92 is moved away from the paper tape T by the third spring 92b.

The cam 86a is rotated and the press-down member 86b is returned to the direction opposite to arrow x by the restoration spring 97a. The holding plate 86 moves away from the sheet bundle B. The tape guide pin 87 rises and moves out of the punch hole H. The rear end of the paper tape T adheres to the pasting part 87a and passes through the punch hole H (FIG. 15D).

The ejector 24 pushes out the sheet bundle B to the direction of arrow j. The rear end of the paper tape T is stripped off the pasting part 87a. The rear end of the paper tape T passes the holding roller 89, and adheres to the sheet bundle B. The stapling unit 80 finishes Bindings of the sheet bundle B with the paper tape T (FIG. 15E). The sheet bundle B with the stapling completed with the paper tape T is slid on the processing tray 18 by the bundle pawl 31 interlocked with the turn of the bundle pawl belt 30 and is stacked in the placing tray 13.

According to the second embodiment, compared with the stapling with metal staples, there is no risk of injuring the handler's hand and user safety is provided. In the case of recycling the sheets P, the need to remove metal staples is eliminated. The paper tape T is produced using the used sheet S which is not reusable, and more effective utilization of the used sheet S is realized.

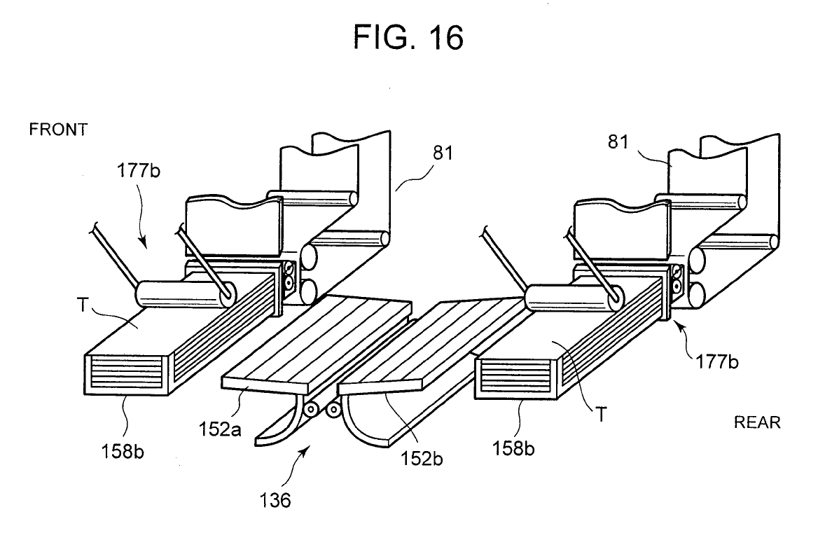

The invention is not limited to the embodiments and various changes and modifications can be made without departing from the scope of the invention. For example, the structure and arrangement position of the binding unit and the tape forming unit are arbitrary. For example, in the second embodiment, the tape forming unit may be changed to a modification 1 shown in FIG. 16. In the modification 1, a lower cutter edge of a tape forming unit 136 is formed as a front-side lower edge 152a and a rear-side lower edge 152b which are separated at the center. After the paper tape T is formed, the front-side lower edge 152a and the rear-side lower edge 152b are inclined toward the front side and the rear side, respectively. Tape supply units 177a and 177b are arranged the front side and the rear side of the lower cutter edges 152, respectively. The paper tapes T formed by the front-side lower edge 152a and the rear-side lower edge 152b are accumulated on a front-side tape tray 158a and a rear-side tape tray 158b respectively. The tape winding position, the tape winding width and so on by the binding unit are not limited, either.

What is claimed is:

1. A sheet finishing device comprising:
a processing tray on which supports sheets having an image formed thereon by an image forming unit;
a binding unit which binds a plurality of the sheets on the processing tray by using a paper tape; and
a stacker which stacks a sheet bundle bound by the binding unit.

2. The device according to claim 1, further comprising a sheet supply portion which supplies a used sheet to the image forming unit.

3. The device according to claim 1, further comprising a tape forming unit which forms the paper tape.

4. The device according to claim 2, further comprising a tape forming unit which forms the paper tape, and a determining unit which determines whether the used sheet in the sheet supply portion is reusable in the image forming unit, wherein in case that the used sheet is reusable, the sheet supply portion supplies the used sheet to the image forming unit, whereas in case that the used sheet is not reusable, the sheet supply portion supplies the used sheet to the tape forming unit.

5. The device according to claim 4, wherein the tape forming unit cuts the used sheet which is not reusable into slits to produce the paper tape and supplies the produced paper tape to the binding unit.

6. The device according to claim 5, wherein the tape forming unit holds the used sheet which is not reusable, in a horizontal state with a supporting unit, produces the paper tape, and then inclines the supporting unit to accumulate the produced paper tape.

7. The device according to claim 5, further comprising a tape supply portion which supplies the paper tape to the binding unit after paste glue on the paper tape.

8. The device according to claim 1, further comprising a punching unit which opens a hole at a binding position in the sheets discharged from the image forming unit, wherein after the hole is opened in the sheets, the sheets are placed on the processing tray.

9. The device according to claim 8, wherein the binding unit passes the paper tape through the hole in the sheets and then winds the paper tape between the hole and an end part of the sheets.

10. The device according to claim 4, wherein the determining unit determines whether the used sheet is reusable by scans a scratch on the sheet.

11. The device according to claim 4, wherein the sheet is a sheet on which number of used times is recorded in advance, and the determining unit determines whether the used sheet is reusable by scans the number of used times.

12. A sheet finishing method comprising:
placing sheets having an image formed thereon on a processing tray;
binding plural sheets on the processing tray by using a paper tape;
discharging a sheet bundle bound by using a paper tape; and
stacking the sheet bundle bound by using a paper tape.

13. The method according to claim 12, wherein a used sheet is cut to form the paper tape.

14. The method according to claim 13, wherein the used sheet is a used sheet that is not reusable in an image forming unit.

15. The method according to claim 14, wherein in the binding, the paper tape is wound between a hole formed in advance in the plural sheets and an end part of the plural sheets.

16. The method according to claim 14, wherein determining whether the used sheet is reusable or un-reusable by scanning a scratch on the used sheet.

17. The method according to claim 14, wherein the sheet is a sheet on which number of used times is recorded in advance, and determining whether the used sheet is reusable or un-reusable by scanning the number of used times.
